(19) United States
(12) Patent Application Publication
(10) Pub. No.: US 2024/0404430 A1
(43) Pub. Date: Dec. 5, 2024

(54) METHOD OF TRANSMISSION OF SIGN LANGUAGE FOR CUSTOMER USE WITH A BUSINESS

(71) Applicant: Drivingo Inc., Christiansburg, VA (US)

(72) Inventor: Levern Currie, Christiansburg, VA (US)

(73) Assignee: Drivingo Inc., Christiansburg, VA (US)

(21) Appl. No.: 18/680,166

(22) Filed: May 31, 2024

Related U.S. Application Data
(60) Provisional application No. 63/469,940, filed on May 31, 2023.

(51) Int. Cl. G09B 21/00; G06F 40/30; G06F 40/58; G06Q 10/087; G06V 40/20

(52) U.S. Cl. CPC G09B 21/009; G06F 40/30; G06F 40/58; G06Q 10/087; G06V 40/28

(57) ABSTRACT

The present invention discloses a method for translating sign language for customer interaction with a business. The method involves receiving an order in sign language from a client, translating the order into text format through a series of processes and a decision-making step, displaying the text format on a visual display for the client, confirming the order by the client, and upon confirmation, fulfilling the client's order. This innovative method facilitates communication between clients using sign language and businesses, enhancing accessibility and inclusivity in customer interactions.

### CROSS-REFERENCE TO RELATED APPLICATIONS

This application is a U.S. Non-Provisional patent application entitled, “METHOD OF TRANSMISSION OF SIGN LANGUAGE FOR CUSTOMER USE WITH A BUSINESS” that claims priority to U.S. Provisional Patent Application No. 63/469,940, filed on May 31, 2023 entitled, “METHOD OF TRANSMISSION OF SIGN LANGUAGE FOR CUSTOMER USE WITH A BUSINESS” the contents of which are hereby fully incorporated by reference.

### FIELD

The present invention relates to the field of method for processing a gesture based interactions based on a set of recognized hand gestures (G06FJ/017).

### BACKGROUND

### Summary of Invention

Incorporating sign language recognition into drive-through restaurant systems is a step towards facilitating inclusivity and accessibility for customers who communicate primarily through sign language. An example system may typically employ computer vision algorithms to interpret gestures and movements made by signers, utilizing strategically positioned cameras to capture and analyze these gestures. Once detected, specific sign language gestures are translated into text format, either by mapping them to a predefined sign language dictionary or using machine learning algorithms to infer meaning. This transcribed text is then integrated into the restaurant's natural language understanding system alongside speech-to-text transcriptions, allowing for seamless order processing. To ensure accuracy, the system may provide visual or auditory feedback to the signer, confirming the interpreted order before finalization. By embracing sign language recognition technology, drive-through restaurants can create a more inclusive environment, ensuring that all customers, regardless of their communication preferences or abilities, can easily and effectively place their orders.

Transcription, in the context of the sign language recognition system, refers to the process of converting sign language gestures into written text. This process involves observing and interpreting the movements, handshapes, and facial expressions used in sign language communication and accurately representing them in written form. Transcription of sign language gestures allows individuals who are not proficient in sign language to understand and access the content of signed messages. Transcription of sign language gestures plays a crucial role in facilitates communication between sign language users and non-signers, as well as in creating accessible materials for deaf and hard-of-hearing individuals.

The method of translation of sign language for customer use with a business is a translation device. The method of translation of sign language for customer use with a business is configured for use with a drive through environment. This disclosure assumes that the natural language preferences of the client is to communicate through a sign language. The method of translation of sign language for customer use with a business comprises a plurality of processes and a first decision. The plurality of processes: a) receive an order in a sign language format from the client; b) translates the received order into a text based format; and, c) fulfills the client's order. The first decision provides the client with the opportunity to confirm the order.

These together with additional objects, features and advantages of the method of translation of sign language for customer use with a business will be readily apparent to those of ordinary skill in the art upon reading the following detailed description of the presently preferred, but nonetheless illustrative, embodiments when taken in conjunction with the accompanying drawings.

In this respect, before explaining the current embodiments of the method of translation of sign language for customer use with a business in detail, it is to be understood that the method of translation of sign language for customer use with a business is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the method of translation of sign language for customer use with a business. It is therefore important that the claims be regarded as including such equivalent construction insofar as they do not depart from the spirit and scope of the method of translation of sign language for customer use with a business. It is also to be understood that the phraseology and terminology employed herein are for purposes of description and should not be regarded as limiting.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIGS. 1 and 1A illustrate a flow chart illustrating a method for processing an image of a sign language gesture in a natural language understanding environment in accordance with some embodiments.

FIG. 2 is an illustration of a high-level block diagram of the system for the natural language understanding environment of FIGS. 1 and 1A of updating text of a display in real-time based on transcription of captured sign language gestures in accordance with some embodiments.

FIG. 3 is a flowchart illustrating a system and computer-implemented method for processing sign language gesture in the natural language understanding environment of FIGS. 1, 1A, and 2 in accordance with some embodiments.

FIG. 4 is a flowchart further illustrating the computer-implemented method from FIG. 3 in accordance with some embodiments.

FIG. 5 is an illustration of a device showing an operational sequence that may be performed when running sign language recognition software with the system of FIG. 3 in accordance with some embodiments.

FIG. 6 is an illustration of a device showing an operational sequence that may be performed when running sign language recognition software with the system of FIG. 3 in accordance with some embodiments.

FIG. 7 is an illustration of a device showing an operational sequence that may be performed when running sign language recognition software with the system of FIG. 3 in accordance with some embodiments.

FIG. 8 is an illustration of a device showing an operational sequence that may be performed when running sign language recognition software with the system of FIG. 3 in accordance with some embodiments.

FIG. 9 is a flowchart illustrating a method conducting business using the system of FIG. 3 in accordance with some embodiments at a drive-thru and Admin Console perspective, according to some embodiments of the present disclosure.

FIG. 10 is an illustration of a high-level block diagram of the computing device of the system for of the natural language understanding environment of FIG. 3 in accordance with some embodiments.

### DETAILED DESCRIPTION

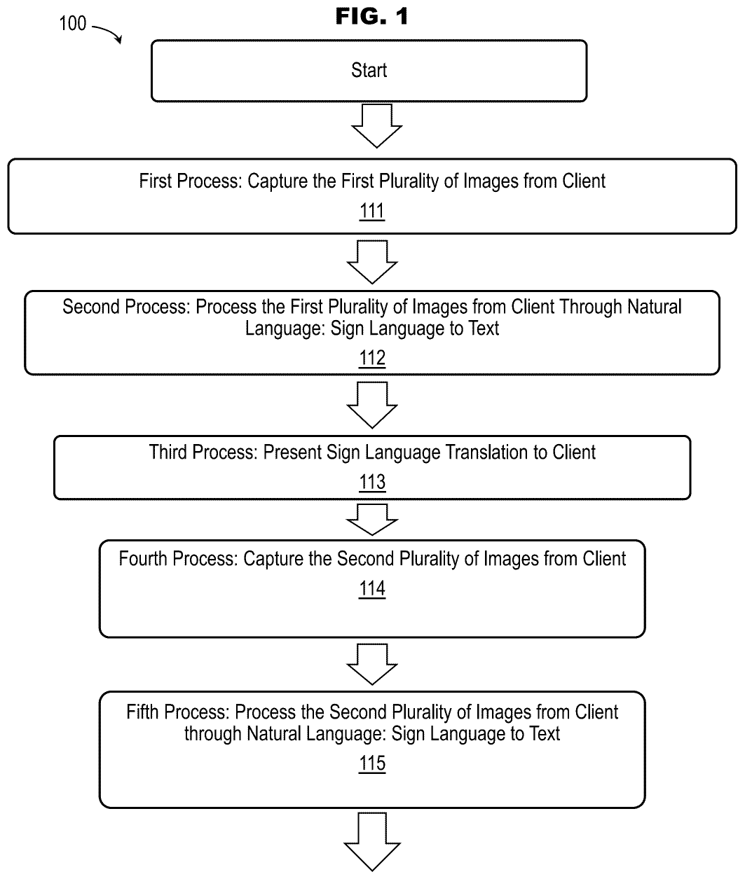

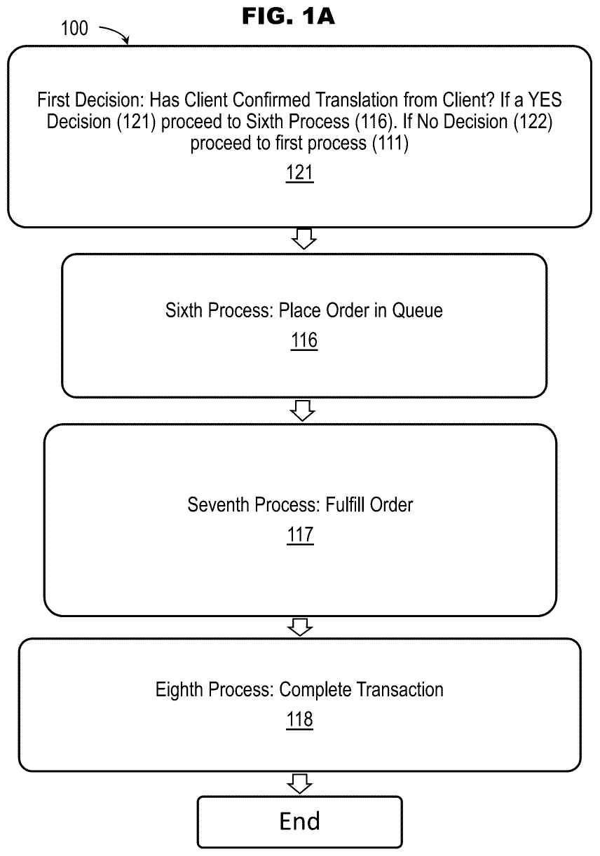

FIGS. 1-10 illustrate example methods and processes to implement a system where sign language gestures are utilized to interact with an ordering interface, establishing the equivalence between a sign language gesture and an order item involves several methods. Firstly, the system relies on semantic mapping, where sign language gestures are predefined to correspond with particular order items. This mapping is typically based on standard sign language conventions or user-defined gestures integrated into the system during its development. Additionally, the system may be trained on a dataset of sign language gestures paired with corresponding order items, utilizing machine learning techniques to recognize patterns and associations between gestures and items. Contextual information is also utilized, as in some implementations, the system may consider factors such as the user's previous interactions or the ongoing conversation to infer the meaning of a gesture accurately. Feedback mechanisms play a role in refining the system's understanding over time, allowing adjustments based on user input. Moreover, integration with natural language understanding enables the system to interpret gestures within the broader context of the conversation, considering linguistic cues and contextual information to determine gesture meaning effectively. Through these methods, the system ensures accurate interpretation of sign language gestures, facilitating communication between users and the ordering interface.

In implementations, this system is a comprehensive platform tailored for the quick-service restaurant (QSR) and fast-casual fast-food industry. It enables users to place orders using multiple languages, including American Sign Language (ASL), through a gesture recognition system. This system supports both fixed, static gestures and dynamic gestures, encompassing hand movements, arm motions, and facial expressions to convey specific words or meanings. Additionally, this system incorporates swiped gestures—up, down, left, right—enhancing user navigation and interaction with the system. The platform also supports multilingual voice interactions. For instance, a native Spanish speaker can interact with the system in Spanish. The system's user interface will display text in Spanish, and the AI will respond in Spanish, facilitating bidirectional, real-time translation and communication. This system is versatile and not confined to drive-thru applications alone. It supports various ordering platforms, including self-serve kiosks, table tablets, and other restaurant infrastructures necessary for order facilitation and payment processing.

In another implementation, in addition to the drive-thru and ordering systems, this system offers an Enterprise Resource Planning (ERP) system. This ERP system facilitates seamless communication with the drive-thru and various ordering platforms. Within the platform, business owners are considered tenants, and each store location operates as a branch. The ERP system allows for the addition and updating of products, customization of pricing, imagery, and menu boards, creation of combo offers, and implementation of upselling strategies. It supports running sales promotions and real-time inventory updates, ensuring stock levels are monitored and notifications are sent when replenishment is needed. The system can automate stock orders or allow manual control by the business owner. The ERP system also manages employee timesheets, tracking clock-ins and clock-outs, and oversees supplier interactions. It integrates with kitchen and cashier displays to streamline order processing, ensuring orders are accurately communicated to the kitchen and cashiers for efficient fulfillment. Payment facilitation is versatile, supporting multiple methods including cards, QR codes, and/or cash. Moreover, the ERP system may provide detailed analytics and reporting capabilities, enabling business owners to track sales, identify popular items, peak times, and generate exportable reports with customizable data selections. Visual representations and data visualizations enhance the analysis process. The system's integration capabilities extend to other inventory management solutions, such as smart fridges, ensuring comprehensive inventory control. By analyzing peak times and historical data, the ERP system can anticipate demand and automate orders to ensure stock availability during busy periods.

As noted above, expanding beyond drive-thrus and fast-food establishments, the platform offers comprehensive solutions applicable to various business environments, including kiosks, tablets, banks, grocery stores, and airports. Leveraging an administrative console and seamless integration with an ERP system, it provides a versatile framework for managing operations, optimizing customer interactions, and streamlining business processes across diverse industries. Within this extended scope, the ERP system serves as a centralized hub for overseeing operations across multiple locations, each designated as a branch within the system architecture. This structure facilitates cohesive management of product inventories, price adjustments, and promotional campaigns tailored to the specific requirements of individual businesses.

Furthermore, the platform facilitates real-time inventory monitoring and order processing, ensuring timely replenishment of stock items to meet demand. This functionality encompasses a wide array of products and services pertinent to various business settings, such as perishable goods in grocery stores and transactional services in banking institutions. Employee management features, including timekeeping and payroll administration, are seamlessly integrated within the ERP system, catering to the staffing needs inherent to diverse business environments. Similarly, supplier management functionalities enable efficient communication and procurement processes, ensuring a steady supply chain flow. Integration with self-service kiosks, tablets, and other digital interfaces enhances customer experiences by offering intuitive ordering and transactional capabilities. Dynamic gesture recognition and multilingual voice interaction functionalities facilitate seamless user interactions across different touchpoints, be it placing orders at a fast-food kiosk or conducting banking transactions at an ATM.

In one or more embodiments, this platform may be useful in fulfilling ADA requirements and compliance for businesses. The platform, which extends beyond drive-thrus and fast-food establishments, offers comprehensive solutions applicable to various business environments. The platform contributes to ADA accessibility and compliance. The platform ensures that websites and mobile apps are accessible to people with disabilities. For instance, individuals who are blind can use screen readers to access visual information on websites or mobile apps as speech. Properly implemented alternative text (also known as “alt text”) for images allows screen readers to convey image content to users who cannot see the images directly. By adhering to these accessibility guidelines, businesses can make their online services, programs, and activities available to everyone, including those with disabilities.

The platform's multilingual voice interaction functionalities enable seamless communication across different languages. Whether it's placing orders at a fast-food kiosk or conducting banking transactions at an ATM, customers and employees can interact effectively regardless of their preferred language. This feature enhances inclusivity and ensures that language barriers do not hinder access to services.

Dynamic gesture recognition allows users to interact with digital interfaces using gestures. For example, customers can navigate self-service kiosks or tablets by swiping, tapping, or performing specific hand movements. Gesture-based interactions accommodate individuals with mobility impairments who may find traditional touchscreens challenging to use.

The platform's functionality ensures timely replenishment of stock items to meet demand. This is crucial for businesses like grocery stores, where perishable goods require careful management. Real-time inventory monitoring also benefits banking institutions, allowing them to efficiently handle transactional services. Seamlessly integrated timekeeping and payroll administration within the ERP system simplify staffing management. Businesses can track employee hours, process payroll, and ensure compliance with labor regulations. These features contribute to a more efficient and organized workforce, benefiting both employees and employers. Supplier management functionalities facilitate efficient communication and procurement processes. Businesses can maintain a steady supply chain flow, ensuring products and services are readily available. Streamlined supplier interactions enhance overall business operations and contribute to compliance by ensuring consistent service delivery.

In summary, this technology not only optimizes business processes but also promotes accessibility, making services available to all individuals, regardless of their abilities or language preferences. Businesses that embrace these features can create a more inclusive and compliant environment for both customers and employees. FIG. 1 illustrates an example method of translation of sign language for customer use with a business 100 (hereinafter invention) is a translation device. The invention 100 is configured for use with a drive through environment. This disclosure assumes that the natural language preference of the client is to communicate through sign language. The invention 100 comprises a plurality of processes 101 and a first decision 102. The plurality of processes 101: a) receive an order in a sign language format from the client; b) translates the received order into a text based format; and, c) fulfills the client's order. The first decision 102 provides the client with the opportunity to confirm the order. The plurality of processes 111 comprises a first process 111, a second process 112, a third process 113, a fourth process 114, a fifth process 115, a sixth process 116, a seventh process 117, and an eighth process 118. The first decision 121 is selected from the group consisting of: a) a YES DECISION 121; and, b) a NO DECISION 122.

The first process 111 is an image capture process. The first process 111 captures a first plurality of images. The first plurality of images captures the gestures performed by the client while communicating their order in sign language. The first process 111 converts the first plurality of images into a file that is subsequently transmitted to the second process 112. The second process 112 is a first natural language processing procedure. The second process 112 is the process that translates the file containing the first plurality of images into a written text format. The second process 112 transmits this written text translation to the third process 113 for further processing. The third process 113 presents the written text translation provided by the second process 112 to the client to confirm the translation of the second process 112 is correct. The completion of the third process 113 initiates the fourth process 114. The fourth process 114 captures a second plurality of images. The second plurality of images captures the gestures performed by the client while communicating their order confirmation order in sign language. The fourth process 114 converts the second plurality of images into a file that is subsequently transmitted to the fifth process 115. The fifth process 115 is a second natural language processing procedure. The fifth process 115 is the process that translates the file containing the second plurality of images into a written text format. The fifth process 115 transmits this choice contained in the second written text translation to the first decision 121 for further processing. The choice transmitted from the fifth process 115 to the first decision 121 is selected from the group consisting of: a) YES DECISIOIN 121; and, b) • NO DECISIOIN 122.

The sixth process 116 places the confirmed client order into the food processing queue of the drive through environment for processing. The completion of the sixth process 116 initiates the seventh process 116. The seventh process 117 is a specific procedure that is defined by the drive through environment operating the invention 100. The seventh process 117 is the process that prepares the materials necessary to fulfill the client order. The eighth process 118 is a specific procedure that is defined by the drive through environment operating the client. The eighth process 118 is the final process that formally completes the transaction between the client and the drive through environment operating the invention 100. The YES DECISION 121 is a choice that is made by the client. A YES DECISION 121 by the client indicates that the second process 112 properly translated the order of the client. The NO DECISION 122 is a choice that is made by the client. The NO DECISION 122 by the client indicates that the second process 112 improperly translated the order of the client. The process map of the invention 100 is in the below paragraphs. After the completion of the first process 111, control of the processes of the invention 100 is transferred to the second process 112. After the completion of the second process 112, control of the process of the invention 100 is transferred to the third process 113. After the completion of the third process 113, control of the process of the invention 100 is transferred to the fourth process 114. After the completion of the fourth process 114, control of the process of the invention 100 is transferred to the fifth process 115.

FIG. 1A illustrates that after the completion of the fifth process 115, control of the processes of the invention 100 is transferred to the first decision 121. In one or more embodiments, there the user may modify the order, change the order, or customize the order For example, a user may decide they want to add pickles or customize their order of french fries to include salt pepper and ketchup.

If the first decision 121 is a YES DECISION 121, then the control of the invention 100 is transferred to the sixth process 116. If the first decision 121 is a NO DECISION 122, then the control of the invention 100 is transferred, or returned, to the first process 111. After the completion of the sixth process 116, control of the processes of the invention 100 is transferred to the seventh process 117. After the completion of the seventh process 117, control of the processes of the invention 100 is transferred to the eighth process 118.

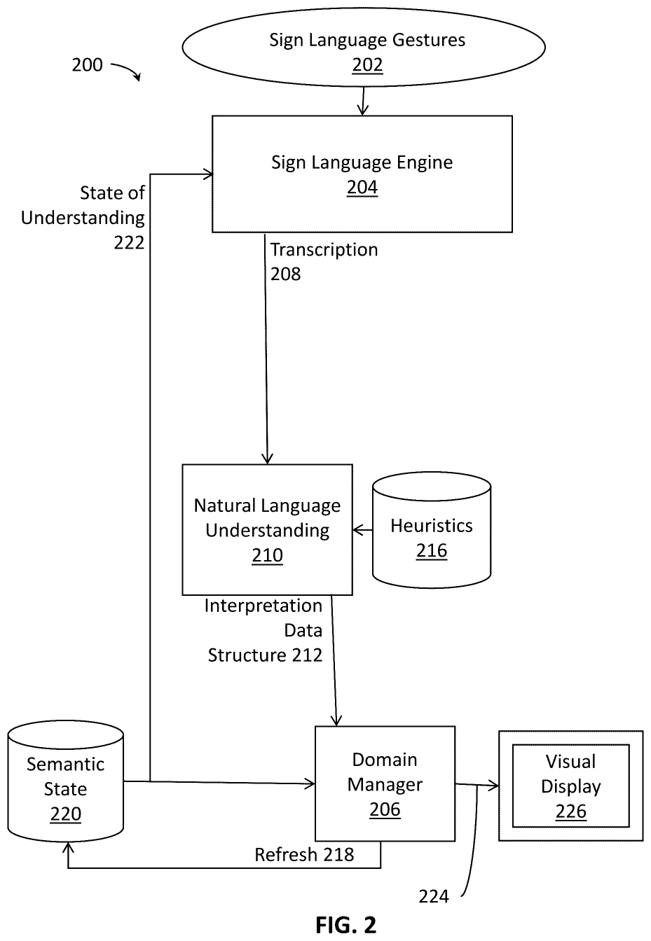

FIG. 2 illustrates a block diagram of system 200 for the natural language understanding environment of updating a display of an electronic device, for example, during order placement in a drive through restaurant environment, in real-time based on detection of a presence of sign language gestures within a transcription of the sign language gestures. System 200 may include sign language gestures 202, a sign language engine 204, and a domain manager 206. Sign language engine 204 produces a continuous transcription 208 of the sign language gestures 202. Natural language understanding 210 outputs interpretation data structure 212. Heuristics 216 may be used to determine the word sequence in which to apply natural language understanding 210. Domain manager 206 continuously refreshes 218 the semantic state 220. The accumulated state of understanding 222 of the sign language gestures 202 is an output of the updated semantic state 220. Domain manager 206 can facilitate 224 visual display 226 to update in real-time. Semantic state 220 change can cause a display update, such as an update to the visual display 226. A visual display 226 could be integrated into an electronic device featuring a graphic user interface. For instance, a text message might appear on the screen for user visibility. Alternatively, the visual display 226 could consist of multiple light-emitting units designed to illuminate in specific patterns to indicate a status update. Alternatively, a series of vibrations could convey the update. Furthermore, updates could manifest as audio outputs, leveraging Text-to-Speech technology.

In implementations, the described methods outline techniques for processing gestures within a natural language understanding framework, applicable to both computer-implemented methods and computer-readable mediums with executable instructions. One embodiment involves employing a sign language engine for recognizing sign language gestures and generating a continuous transcription thereof. For instance, users interact with a virtual assistant via an electronic device equipped with a visual display to capture sign language commands, questions, or requests. While continuous transcription is a primary focus, variations may include intermittent transcription or even delays. The sign language engine receives input gestures from cameras or video systems and produces a text transcription, which is further analyzed using sentence-level natural language understanding. An arbitrator, positioned before the domain handler, selects interpretations based on the natural language understanding results. Inputs to the arbitrator encompass data structures, summary messages from integrators, or raw fragments, all necessitating processing by the domain handler. In an alternative approach, transcriptions are analyzed to identify token sequences hypothesized as full-sentence gestures, then subjected to natural language understanding. This process involves identifying question words or pauses to delineate sentence boundaries. A dialog manager may control conversations and prompt users for additional information, facilitating semantic state updates in real-time during gesture interpretation. This differs from conventional systems, which rely solely on verbal word sequences for autocomplete suggestions, as the described approach considers the semantics of gestures at each stage.

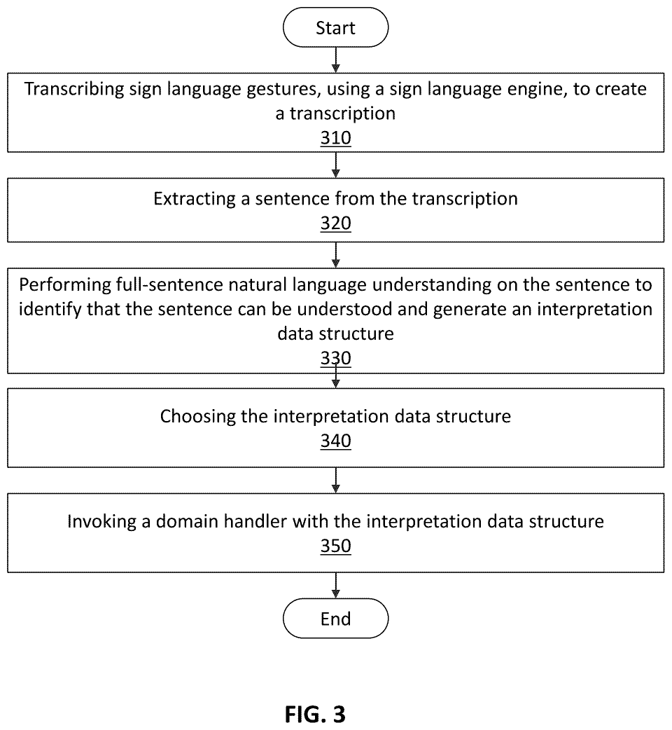

FIG. 3 is a flowchart illustrating a computer-implemented method, according to some embodiments of the present disclosure. In some embodiments, at block 310, the computer-implemented method may include transcribing sign language gestures, using a sign language engine, to create a transcription. At block 320, the computer-implemented method may include extracting a sentence or one or more words from the transcription. At block 330, the computer-implemented method may include performing full-sentence natural language understanding on the sentence to identify that the sentence can be understood and generate an interpretation data structure. At block 340, the computer-implemented method may include choosing the interpretation data structure. At block 350, the computer-implemented method may include invoking a domain handler with the interpretation data structure. In some embodiments the domain handler outputs a semantic state and displays context-relevant information suggesting at least one gesture to sign, the suggestion depending on the semantic state. In some embodiments, the domain handler may cause a user interface to change on a visual display in real-time. In some embodiments, the visual display may be configured for use with a drive through environment. In some embodiments, the computer-implemented method may include, updating, using the domain handler, a portion of a semantic state.

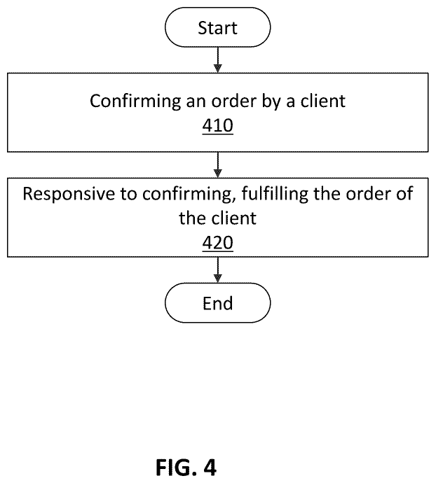

FIG. 4 is a flowchart that further describes the computer-implemented method from FIG. 3, according to some embodiments of the present disclosure. In some embodiments, at block 410, the computer-implemented method may include confirming an order by a client. In some embodiments, confirming is via a graphic user interface of a visual display. In one or more embodiments, at this point 410, the user may modify the order, change the order, or customize the order. For example, a user may decide they want to add pickles or customize their order of french fries to include salt pepper and ketchup. In some embodiments, at block 420, the computer-implemented method may include, responsive to confirming, fulfilling the order of the client.

In one or more embodiments, there may be an additional module 100 at the cashier or payment station which allows the user to add additional items or products after the order has been placed. The user may use gesturing or verbal communication to place the order after the order has been placed. For example, a customer may decide they wanted to add a milkshake or order of fries to the order. In one or more instances, this ability may only be utilized by the cashier or entered by the cashier.

In one or more embodiments, the invention may provide an assistance module. The assistance module may be activated or accessed by a specific gesture or specific command. For example, a customer may say, “I need help” or gesture for help. The assistance module may notify the customer service attendant to come out to assist the customer. If a customer service attendant is not available, an employee or staff member may come out to assist the customer. In one or more instances, the business may employ one or more special assistance for this purpose. The assistance module may be implemented as a module of the invention or as a user interface within the existing invention, or as a button or feature of the existing invention.

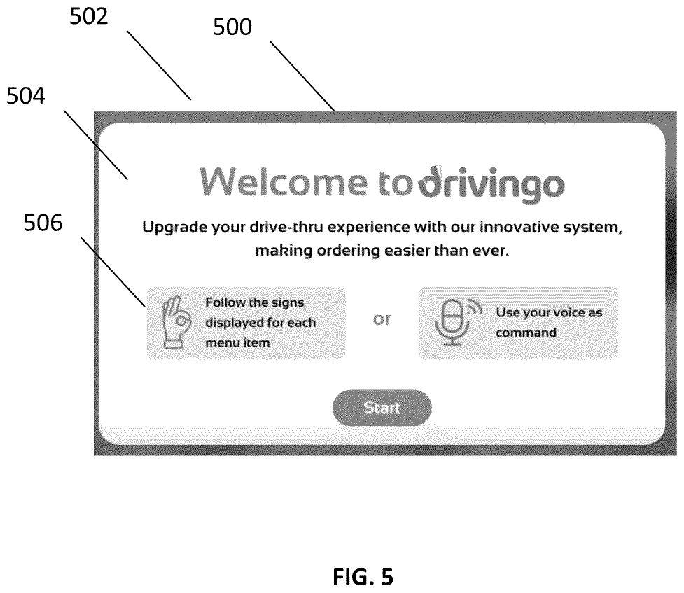

FIG. 5 is an illustration of a device showing an operational sequence that may be performed when running a semantic completion software. A visual display 500 or electronic device shows an operational sequence 502 that may be performed when running a semantic completion software. In particular, a welcome page is displayed at a user interface 504. The user interface 504 displays a set of instructions 506 to a client (not shown) and/or a user. When a user accesses the system, they are greeted by the welcome page displayed on the user interface 504. This page serves as an entry point, providing essential information and guidance to both clients and users engaging with the system. Alongside welcoming messages, the user interface 504 also presents a set of instructions 506 to assist users in navigating the platform or understanding its functionalities. These instructions are designed to facilitate a smooth and intuitive user experience, ensuring that clients and users can easily grasp how to interact with the system effectively. By prominently displaying such information, the welcome page sets the tone for user engagement and establishes a positive initial interaction with the system.

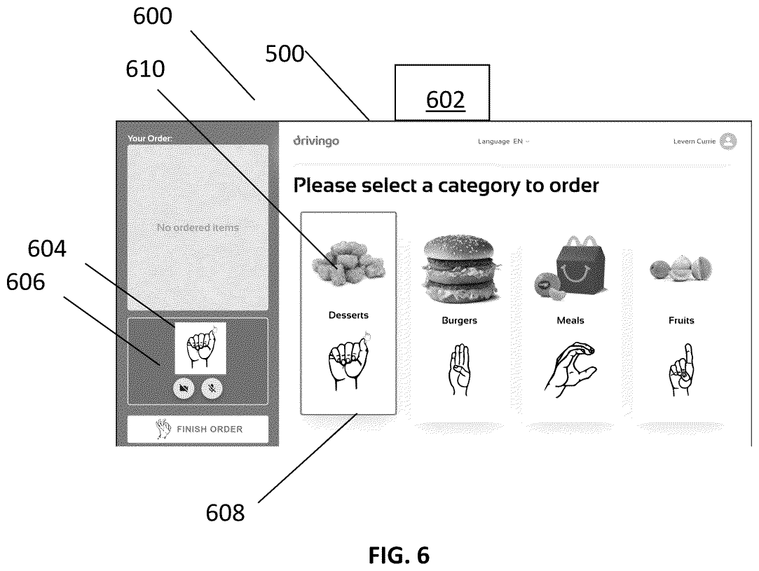

FIG. 6 is an illustration of a device showing an operational sequence 600 that may be performed on the visual display 500 of FIG. 5 when running the semantic completion software. A sensor 602 such as a camera and/or video recorder may capture one or more sign language gestures 604 from one or more hands of a client and display the one or more sign language gestures in viewing window 606. Semantic completion is shown, whereby the semantic state is updated 608 and displayed to a user in real time. In an example, a client gestures the sign for order item 610 being tater tots and the order item 610 is displayed on the screen of the visual display 500. Based on transcription, a list of suggestions for drink order and side dish options may be displayed to show possible order options being a burger meal, and/or fruit to name a few examples.

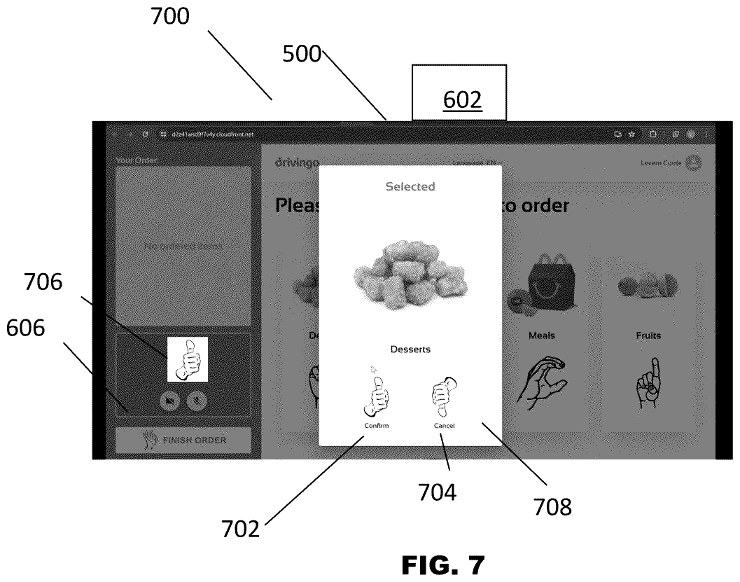

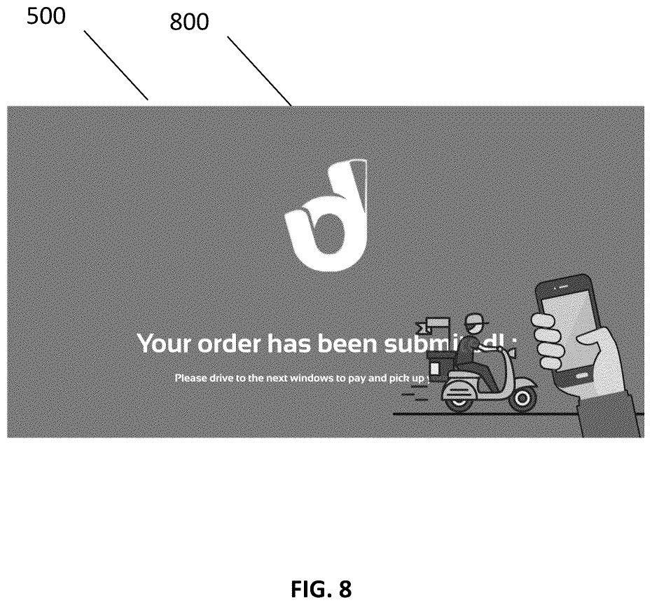

FIG. 7 is an illustration of a device showing an operational sequence 700 that may be performed on the visual display 500 of FIG. 5 when running a semantic completion software. A client may verify the selection via a touch screen or using sign language gestures 706 to indicate confirmation 702 or a cancelation 704 of an order. Semantic completion is shown, whereby the semantic state is updated 708 and displayed to a user in real-time. In this example, a client provides a sign language gesture 706 for confirmation and the image is captured by the sensor 602 and displayed in viewing window 606. Where a client provides a sign language gesture for confirmation, the process involves capturing the image of the gesture using the sensor 602. One example of such a sensor could be a camera sensor, capable of recording visual input. This sensor would capture the client's sign language gesture in the form of an image or video, transmitting it to the system for interpretation. Alternatively, a depth sensor, such as a time-of-flight camera, could provide additional depth information along with visual input, enhancing the system's ability to interpret three-dimensional hand movements accurately. Another possibility is an infrared sensor, which could detect heat signatures or infrared radiation emitted by the client's hands during the gesture, particularly useful in low-light environments. Additionally, specialized gesture recognition sensors, based on radar or capacitive sensing technologies, could specifically detect and interpret hand movements associated with sign language gestures. The choice of sensor would depend on factors such as accuracy, reliability, cost, and the specific requirements of the system, ensuring the effective capture and interpretation of sign language gestures for confirmation. The confirmed order will be submitted for fulfillment as shown in FIG. 8.

FIG. 8 is an illustration of a device showing an operational sequence 800 that may be performed on the visual display 500 of FIG. 5 when running a semantic completion software. Order fulfillment is submitted for processing on a confirmed order. The term semantic completion software includes a system capable of enhancing or completing the meaning of a given sign language input in a semantic context. The specific process being illustrated involves the submission of order fulfillment for processing. The system is managing orders, typically in a business or service context. The term confirmed order suggests that the order has been confirmed or validated by the client, indicating that it's ready for processing or execution. The visual display serves as the interface through which this operational sequence is presented, to facilitate users or operators interacting with the system using this display. The operational sequence may involve multiple steps or stages, with each step being visually represented on the display to provide feedback or guidance to the user.

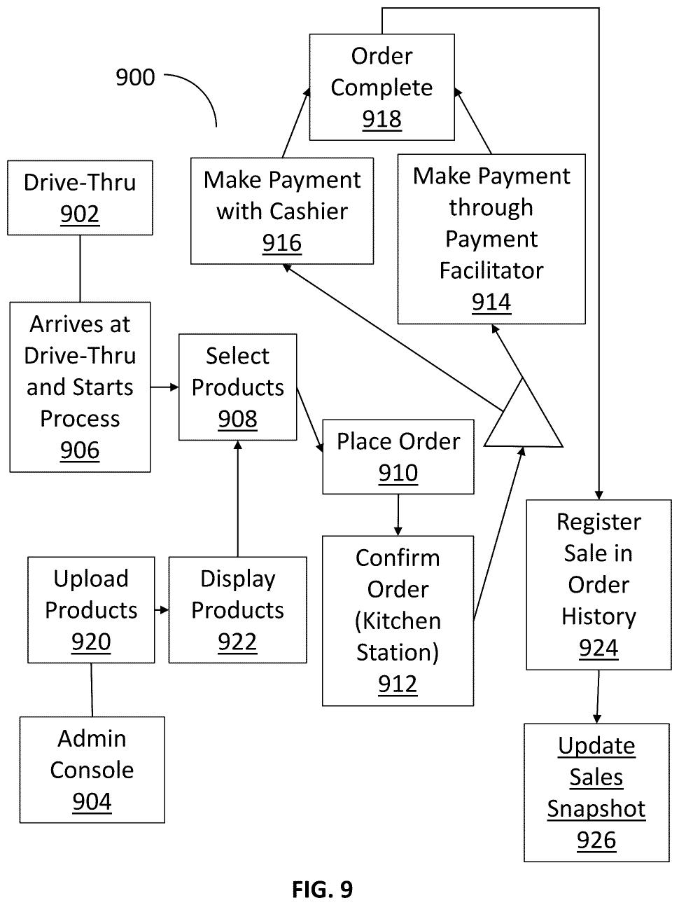

FIG. 9 is a flowchart illustrating a method conducting business 900 at a drive-thru process 902 and at an Admin Console process 904 perspective, according to some embodiments of the present disclosure. Focusing on the drive-thru process 902, at block 906, the drive-thru process begins with a client arriving at the drive-thru to start the ordering process. At block 908, the client selects a product and/or an order item. At block 910 a client orders a selected product by performing the sign language gesture for the desired product so that a sensor can capture an image of the gesture and process the sign language gesture to text using processes discussed in FIGS. 1-8. At block 912, the client confirms the order at a kitchen station, for example. At block 914, the client may make an electronic card payment via a payment facilitator. In another embodiment, at block 916, the client may make a payment with the cashier. At block 918 the order is fulfilled and completed. Turning now to the Admin Console process 904, at block 920, products are uploaded. At block 922, the uploaded products are displayed to a user. After an order is completed, at block 924, the sale is registered in the order history. At block 926, the sales snapshots are updated.

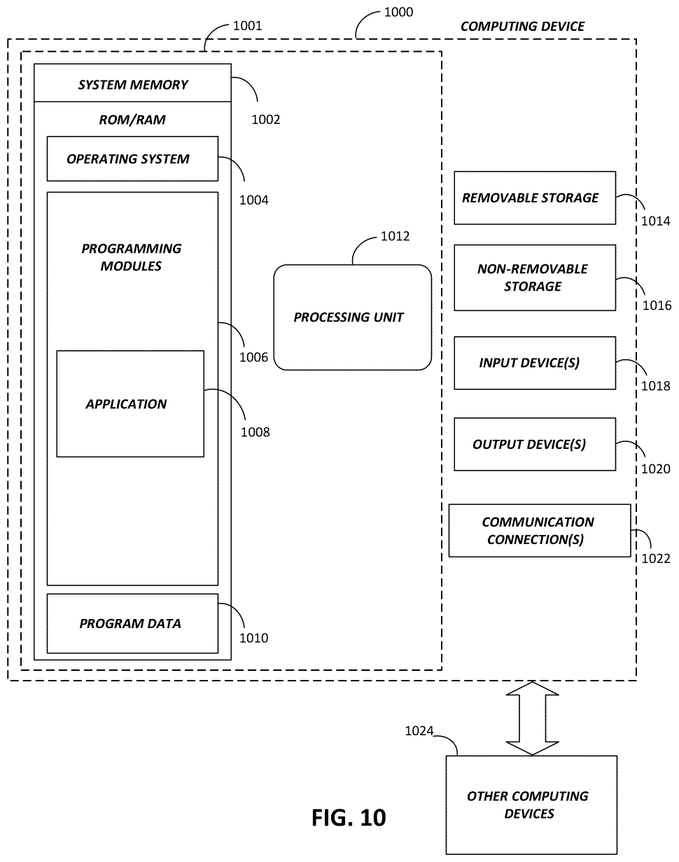

FIG. 10 is an illustration of a high-level block diagram of the computing device 1000 of the system for of the natural language understanding environment of FIG. 3 in accordance with some embodiments. The computing device 1000 comprises an arrangement of interconnected components to facilitate computational tasks and interaction with users and external systems. It features a computing system 1001 with system memory 1002 composed of both volatile Random Access Memory (RAM) and non-volatile Read-Only Memory (ROM), housing firmware and operating system instructions for system initialization and operation. The operating system 1004 orchestrates the utilization of hardware resources, managing memory, processes, and input/output operations. Programming modules 1006, including applications 1008 tailored for specific functionalities, leverage the processing unit's capabilities to execute tasks efficiently. Program data 1010, encompassing user-generated content and configuration information, resides in various storage mediums, including non-removable internal storage such as Solid State Drives (SSDs) and removable devices like USB flash drives. The processing unit 1012, often referred to as the Central Processing Unit (CPU), serves as the computational powerhouse within the computing device 1000. It is integrated into the system architecture, interfacing with various components to execute instructions and perform tasks.

For example, the CPU communicates with system memory 1002, including both RAM and ROM, to fetch instructions and data for processing. The operating system 1004 manages this interaction, coordinating the flow of information between the CPU and system memory 1002 to ensure efficient execution of programs and applications 1008. Programming modules 1006, including applications 1008 and system utilities, utilize the CPU's processing capabilities to perform computational tasks. The CPU executes instructions encoded within these modules, performing arithmetic, logical, and control operations as directed by the software. Additionally, the CPU interfaces with storage devices, both non-removable 1016 and removable 1014, to read and write data as required by the software executing on the system. Input devices 1018 provide the CPU with user-generated input, which the CPU processes and interprets to carry out corresponding actions. For example, input devices 1018 such as keyboards and mice capture user input, while output devices 1020 like monitors and printers present processed information. Output devices 1020 receive signals from the CPU, presenting processed information to users in various forms. These devices may include displays, printers, speakers, and other peripherals.

Communication connections 1022 in the computing device 1000 enable interaction with external systems, networks, and peripherals. Wired connections, such as Ethernet, USB, HDMI, and Thunderbolt, provide reliable high-speed data transmission within local area networks (LANs) and across devices, facilitating tasks ranging from file transfer to multimedia playback. Wireless technologies like Wi-Fi, Bluetooth, NFC, and cellular networks offer flexible connectivity options, allowing devices to communicate without physical cables and providing internet access in diverse environments. Wi-Fi serves as a ubiquitous solution for wireless LAN connectivity, while Bluetooth facilitates short-range device pairing and data exchange. NFC enables contactless transactions and device interactions within close proximity, while cellular networks ensure internet connectivity on the go. These communication connections 1022 empower the computing device 1000 to exchange data, access network resources, and collaborate with other devices, enhancing productivity and facilitate application 1008. Furthermore, bidirectional communication connections enable the CPU to interact with other computing devices 1024 and systems, facilitating data exchange and collaborative workflows.

The following definitions were used in this disclosure:

Alphabet: As used in this disclosure, an alphabet refers to a plurality of images used in a written language. Each image selected from the plurality of images is called a letter. Each letter is an indicia that is placed in a predetermined order, referred to as a spelling, with one or more additional letters selected from the alphabet to generate the sentiment of a word of the language. Each letter further imparts phonetic information. The indicia of each letter, both alone and in a combination with other letters, provides a sentiment indicating the pronunciation of the word. The English alphabet, also referred to as the Carolingian alphabet, is a 26 letter alphabet derived from the Latin alphabet. The English alphabet comprises the letters: A, B, C, D, E, F, G, H, I, J, K, L, M, N, O, P, Q, R, S, T, U, V, W, X, Y, and Z. In the English language, a collection of objects that are alphabetically organized are organized in the order presented above.

Casual Dining Environment: As used in this disclosure, a casual dining environment refers to a restaurant wherein: 1) the food served is prepared on premises; 2) table seating is available within the restaurant; and, 3) no or limited tableside service is available from the restaurant.

Client: As used in this disclosure, a client is an individual who is designated to receive a service.

Distinguishable and Unique: As used in this disclosure, the terms distinguishable and unique are applied to objects contained in a plurality of objects. An object selected from the plurality of objects is referred to as distinguishable if the selected object has a characteristic that allows the selected object to be differentiated from at least one unselected objected remaining in the plurality of objects. A first object selected from the plurality of objects is referred to as unique if the selected object has a characteristic that allows the selected object to be differentiated from any second object selected from the plurality of objects. The term indistinguishable indicates that the objects contained in the plurality of objects are neither distinguishable nor unique.

Drive Through Dining Environment: As used in this disclosure, a drive through dining environment refers to a restaurant wherein food and beverage based transactions do not require a client to leave their vehicle.

Image: As used in this disclosure, an image is an optical representation or reproduction of an indicia or of the appearance of something or someone. See indicia sentiment optical character recognition. See Label and Pattern.

Indicia: As used in this disclosure, the term indicia refers to a set of markings that identify a sentiment. See sentiment.

Natural Language: All used in this disclosure, a natural language refers to a language used by individuals within a society to communicate directly with each other.

Natural Language Processing: As used in this disclosure, a natural language processing refers to a collection of algorithms that use one or more natural languages as an input. The elements of natural language processing include, but are not limited to: a) capturing a sample of a first natural language from spoken, text (written), or gesture based sources: b) comprehending the captured sample of the first natural language; c) acting on the comprehension of the captured sample of the first natural language to generate an output; and, d) presenting the output as a natural response. The natural language response is presented in a language selected from the group consisting of: e) the first natural language or, f) a second natural language that is different from the first natural language. A device that processes a first natural language into a second natural language is called a translation device.

Sentiment: As used in this disclosure, a sentiment refers to a symbolic meaning or message that is communicated through the use of an object or an image, potentially including a text based image.

Sign language: As used in this disclosure, a sign language is a natural language that is based on visually distinct signs and gestures. The sign language is commonly used by individuals with hearing disabilities.

Translate: As used in this disclosure, to translate means to convert data contained in a first organizational or operational structure into a second organizational or operational structure. The term translate often refers to the conversion of data existing in a first natural language into a second natural language.

Write and Draw: As used in this disclosure, the verbs to write and draw mean to prepare an image for display. The prepared image is formed from indicia that identify one or more sentiments hat the preparer wishes to express. The term to write is taken to mean that an alphabet was used as the primary means used to prepare the presented sentiment. The term to draw is taken to mean that non-alphabetic indicia were used as the primary means used to prepare the presented sentiment.

With respect to the above description, it is to be realized that the optimum dimensional relationship for the various components of the invention described above and in the illustrations include variations in size, materials, shape, form, function, and manner of operation, assembly and use, are deemed readily apparent and obvious to one skilled in the art, and all equivalent relationships to those illustrates in the drawings and described in the specification are intended to be encompassed by the invention.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method of translation of sign language for customer use with a business comprising:
receiving an order, by one or more sensors, in a sign language format from a client;
translating the received order into a text based format, by a plurality of processes and a first decision;
displaying, on a visual display, the text based format to the client;
confirming the order by the client; and
responsive to confirming, fulfilling the order of the client.

2. The method of claim 1, wherein the translating is performed by a translation device.

3. The method of claim 2, wherein the translation device is a sign language engine.

4. The method of claim 1, wherein the visual display is configured for use with a drive through environment.

5. A computer-implemented method comprising:
transcribing sign language gestures, using a sign language engine, to create a transcription;
extracting a sentence from the transcription;
performing full-sentence natural language understanding on the sentence to identify that the sentence can be understood and generate an interpretation data structure;
choosing the interpretation data structure; and
invoking a domain handler with the interpretation data structure.

6. The computer-implemented method of claim 5, wherein outputting, by the domain handler, a semantic state and displaying context-relevant information suggesting at least one gesture to sign, the suggestion depending on the semantic state.

7. The computer-implemented method of claim 5, wherein the domain handler causes a user interface to change on a visual display in real-time.

8. The computer-implemented method of claim 7, wherein the visual display is configured for use with a drive through environment.

9. The computer-implemented method of claim 5, further comprising updating, using the domain handler, a portion of a semantic state.

10. The computer-implemented method of claim 5, further comprising confirming an order by a client.

11. The computer-implemented method of claim 10, wherein confirming via a graphic user interface of a visual display.

12. The computer-implemented method of claim 11, further comprising responsive to confirming, fulfilling the order of the client.

13. A computer-readable medium comprising instructions which, when executed by a computer, cause the computer to carry out the steps of:
transcribing sign language gestures, using a sign language engine, to create a transcription;
extracting a sentence from the transcription;
performing full-sentence natural language understanding on the sentence to identify that the sentence can be understood and generate an interpretation data structure;
choosing the interpretation data structure; and
invoking a domain handler with the interpretation data structure.

14. The computer-readable medium of claim 13, wherein outputting, by the domain handler, a semantic state and displaying context-relevant information suggesting at least one gesture to sign, the suggestion depending on the semantic state.

15. The computer-readable medium of claim 13, wherein the domain handler causes a user interface to change on a visual display in real-time.

16. The computer-readable medium of claim 15, wherein the visual display is configured for use with a drive through environment.

17. The computer-readable medium of claim 13, further comprising confirming an order by a client.

18. The computer-readable medium of claim 13, wherein confirming via a graphic user interface of a visual display.

19. The computer-readable medium of claim 18, further comprising responsive to confirming, fulfilling an order of a client.

20. The computer-readable medium of claim 13, further comprising updating, using the domain handler, a portion of a semantic state.
